(19) United States
(12) Patent Application Publication
(10) Pub. No.: US 2013/0229721 A1
(43) Pub. Date: Sep. 5, 2013

(54) DRIVE UNIT, METHOD OF MANUFACTURING THE SAME, LENS MODULE, AND IMAGE PICKUP UNIT

(71) Applicants: Takehisa Ishida, Tokyo (JP); Nobuyuki Nagai, Kanagawa (JP); Yusaku Kato, Tokyo (JP)

(72) Inventors: Takehisa Ishida, Tokyo (JP); Nobuyuki Nagai, Kanagawa (JP); Yusaku Kato, Tokyo (JP)

(21) Appl. No.: 13/883,504

(22) PCT Filed: Nov. 2, 2011
(86) PCT No.: PCT/JP2011/075284

§ 371 Date: May 3, 2013

(30) Foreign Application Priority Data
Nov. 12, 2010 (JP) 2010-254154

(51) Int. Cl. G02B 7/04

(52) U.S. Cl. CPC G02B 7/04
USPC 359/824; 29/428; 359/823

(57) ABSTRACT

A drive unit capable of reducing size while maintaining drive characteristics, a method of manufacturing the same, a lens module, and an image pickup unit are provided. A drive unit includes: a fixing member; an actuator device having a first end portion directly or indirectly fixed by the fixing member; and a reinforcing member (reinforcing layer) provided on part or all of the actuator device. Mechanical strength of the actuator device is secured even when the width of the actuator device (for example, the width W12) is narrowed, by providing the above-described reinforcing member.

### TECHNICAL FIELD

The present invention relates to a drive unit that uses a predetermined actuator device, to a method of manufacturing the drive unit, and to a lens module and an image pickup unit that include such a drive unit.

### BACKGROUND ART

Recently, mobile electronic apparatuses such as mobile phones, personal computers (PC), and PDAs (personal digital assistants) have been remarkably obtaining high functions and a mobile electronic apparatus is typically provided with an image pickup function by providing a lens module. Such mobile electronic apparatuses perform operation such as focusing and zooming by allowing a lens in the lens module to travel along an optical axis thereof.

It has been typical that movement of a lens in a lens module is performed using, for example, a voice coil motor, a stepping motor, or the like as a drive section. On the other hand, recently, those utilizing a predetermined actuator device as the drive section have been developed in terms of reducing size. Examples of such actuator devices include a polymer actuator device (see Patent Literatures 1 and 2), a piezoelectric device, and a bimetal device. Out of these devices, the polymer actuator device may be, for example, a device in which an ion-exchange resin film is interposed between a pair of electrodes. In such a polymer actuator device, a potential difference is generated between the pair of electrodes, and thereby, the ion-exchange resin film is displaced in a direction perpendicular to a film plane.

### CITATION LIST

### Patent Literature

[Patent Literature 1] Japanese Unexamined Patent Application Publication No. 2006-293006

[Patent Literature 2] Japanese Unexamined Patent Application Publication No. 2006-172635

### SUMMARY OF THE INVENTION

Typically, a drive unit using an actuator device as described above is a cantilever actuator that drives a driving target by fixing a first end portion (fixed portion) thereof and displacing a second end portion (movable portion) thereof. In recent years, it has been desired to reduce width (length in a direction perpendicular to a direction extending from the first end toward the second end of the actuator device) of a cantilever as much as possible, for example, in terms of freedom in design (size reduction in structure) in such a cantilever actuator.

However, since it may be necessary to support the driving target by the cantilever, it may be necessary to secure a certain width to allow the actuator device to have sufficient strength (mechanical strength) to support the driving target. Therefore, there has been a limit in reducing dimensions in a width direction of the cantilever. Accordingly, it has been desired to propose a drive unit capable of reducing size while maintaining drive characteristics.

The present invention has been made in view of the forgoing issue and it is an object of the present invention to provide a drive unit capable of reducing size while maintaining drive characteristics, a method of manufacturing the drive unit, a lens module, and an image pickup unit.

A drive unit according to an embodiment of the present invention includes: a fixing member; an actuator device having a first end portion directly or indirectly fixed by the fixing member; and a reinforcing member provided on part or all of the actuator device.

A lens module according to an embodiment of the present invention includes: a lens; and the above-described drive unit according to the embodiment of the present invention driving the lens.

An image pickup unit according to an embodiment of the present invention includes: a lens; an image pickup device acquiring an image pickup signal resulting from imaging by the lens; and the above-described drive unit, driving the lens, according to the embodiment of the present invention.

A method of manufacturing a drive unit according to an embodiment of the present invention includes: forming an actuator device; forming a reinforcing member on part or all of the actuator device; and directly or indirectly fixing a first end portion of the actuator device by a fixing member.

In the drive unit, the method of manufacturing the drive unit, the lens module, and the image pickup unit according to the embodiments of the present invention, the reinforcing member is provided on part or all of the actuator device. Therefore, mechanical strength of the actuator device is secured even when a width of the actuator device (length in a direction perpendicular to a direction extending from the first end toward a second end of the actuator device) is narrowed.

According to the drive unit, the method of manufacturing the drive unit, the lens module, and the image pickup unit according to the embodiments of the present invention, the reinforcing member is provided on part or all of the actuator device. Therefore, mechanical strength of the actuator device is secured while setting the width of the actuator device to be narrow. Therefore, size reduction is achievable while maintaining drive characteristics.

### BRIEF DESCRIPTION OF THE DRAWINGS

FIG. 1 is a schematic plan view illustrating an outline configuration of a drive unit according to an embodiment of the present invention.

FIG. 2 is a schematic view illustrating a side-face configuration of the drive unit shown in FIG. 1.

FIG. 3 is a cross-sectional view illustrating a detailed configuration of an actuator device (polymer actuator device) shown in FIG. 1.

FIG. 4 is a schematic cross-sectional view for explaining about basic operation of the polymer actuator device shown in FIG. 3.

FIG. 5 is a schematic view illustrating an outline configuration and operation of a drive unit according to Comparative Example 1.

FIG. 6 is a schematic view illustrating an outline configuration and operation of a drive unit according to Comparative Example 2.

FIG. 7 is a schematic plan view illustrating outline configurations of drive units according to Modifications 1 and 2.

FIG. 8 is a schematic view illustrating an outline configuration and operation of a piezoelectric device that functions as an actuator device according to Modification 3.

FIG. 9 is a schematic view illustrating an outline configuration and operation of a bimetal device that functions as an actuator device according to Modification 4.

FIG. 10 is a perspective view illustrating a configuration example of an electronic apparatus including an image pickup unit according to Application Example 1 of the drive unit of any of the embodiment and the modifications.

FIG. 11 is a perspective view illustrating the electronic apparatus shown in FIG. 10 from a different direction.

FIG. 12 is a perspective view illustrating a main part configuration of the image pickup unit shown in FIG. 11.

FIG. 13 is an exploded perspective view illustrating a lens module shown in FIG. 12.

FIG. 14 is a schematic view illustrating a side-face configuration and a planar configuration of the lens module shown in FIG. 12.

FIG. 15 is a cross-sectional view illustrating a detailed configuration of part of actuator devices (polymer actuator devices), fixing members, and fixed electrodes shown in FIG. 13.

FIG. 12 is a side-face schematic view illustrating operation of the lens module shown in FIG. 12.

FIG. 17 is a schematic view illustrating a side-face configuration and a planar configuration of a lens module according to Modification 3.

FIG. 18 is a schematic view illustrating a side-face configuration and a planar configuration of a lens module according to Application Example 2.

FIG. 19 is a perspective view illustrating a method of manufacturing a drive unit in the lens module shown in FIG. 18 in process order.

FIG. 20 is a perspective view, a plan view, and a side-face view each illustrating a process following a process shown in FIG. 19.

### MODE(S) FOR CARRYING OUT THE INVENTION

An embodiment of the present invention will be described in detail below with reference to the drawings. Description will be given in the following order.
1. Embodiment (an example using a polymer actuator device as an actuator device)
2. Modifications

Modifications 1 and 2 (examples in which a reinforcing layer has a wide-width portion and a narrow-width portion)

Modification 3 (an example using a piezoelectric device as the actuator device)

Modification 4 (an example using a bimetal device as the actuator device)
3. Application Examples 1 and 2 (examples in which a drive unit is applied to a lens module and to an image pickup unit)

### Embodiment

### [General Configuration of Drive Unit 1]

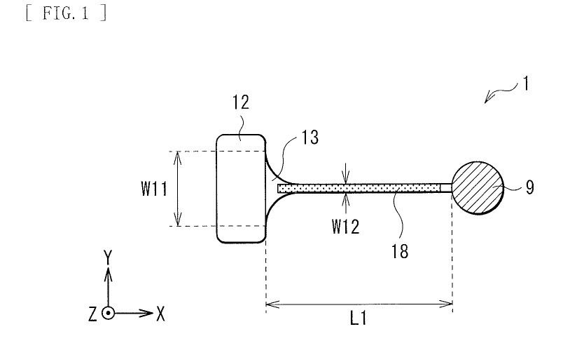

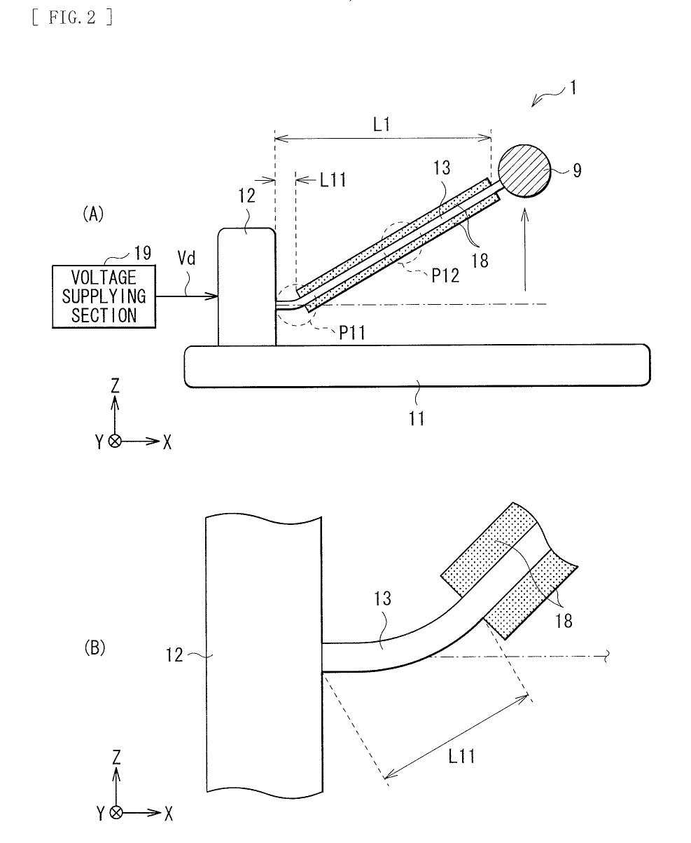

FIG. 1 schematically illustrates an outline configuration of a drive unit (drive unit 1) according to an embodiment of the present invention in a plan view (an X-Y plane view, a top view). Further, Part (A) of FIG. 2 schematically illustrates a side-face configuration (Z-X side-face configuration) of the drive unit 1. Part (B) of FIG. 2 illustrates an enlarged part of Part (A) of FIG. 2 (vicinity of a region designated by a symbol P1).

The drive unit 1 is a cantilever actuator that drives (along a Z axis in this example) a driving target 9. The drive unit 1 includes a supporting member 11, a fixing member 12, an actuator device 13, a reinforcing layer 18 (reinforcing member), and a voltage supplying section 19.

The supporting member 11 is a base member (base) that supports the drive unit 1 as a whole. The supporting member 11 is so arranged as to extend on an XY plane in this example. The supporting member 11 may be formed, for example, of a hard resin material such as a liquid crystal polymer.

The fixing member 12 is a member that fixes a first end portion (fixed portion) of the actuator device 13 and stands on the supporting member 11 in a Z-axis direction. The fixing member 12 may also be formed, for example, of a hard resin material such as a liquid crystal polymer.

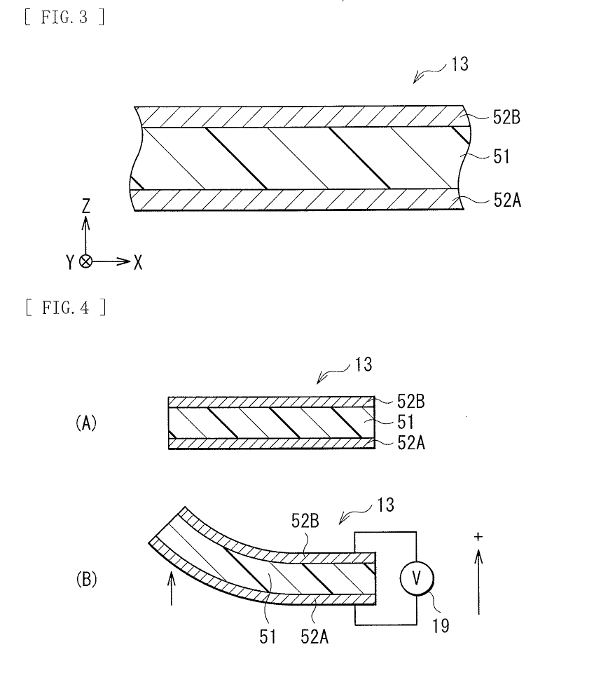

The actuator device 13 is a device that drives the driving target 9 along the Z axis. The actuator device 13 is configured of a flat-plate-like (thin-plate-like) polymer actuator device in this example. In the actuator device 13, a length from the first end (closer to the fixing member 12) to the second end (closer to the driving target 9, closer to the movable portion) is L1. Further, concerning a width of the actuator device 13, a width W11 of a portion closer to the fixing member 12 is larger than a width W12 of a portion closer to the driving target 9 in this example (W11>W12). In other words, the actuator device 13 has a wide-width portion closer to the fixing member 12 and has a narrow-width portion closer to the driving target 9. It is to be noted that description will be given later of a detailed configuration of the actuator device 13 configured of the polymer actuator device (FIG. 3).

The reinforcing layer 18 is a member that reinforces strength (mechanical strength) of the actuator device 13 by being provided on part or all of the actuator device 13. The reinforcing layer 18 is provided on both a front face and a back face (a pair of main surfaces) of the actuator device 13 in this example. However, the reinforcing layer 18 may be provided on one of the front and back faces of the actuator device 13. It is preferable that the above-described reinforcing layer 18 be provided, for example, on part or all of the above-described narrow-width portion (portion with the width W12) of the actuator device 13. One reason for this is that the narrow-width portion of the actuator device 13 contributes relatively a little to displacement (deformation) of the device as will be described later. The reinforcing layer 18 is provided not only on the narrow-width portion of the actuator device 13 but also on part or all of the above-described wide-width portion (portion with the width W11) in this example. Specifically, the reinforcing layer 18 is continuously (integrally) provided from the narrow-width portion over the wide-width portion of the actuator device 13. The above-described reinforcing layer 18 may be formed, for example, of a resin material such as polyimide (PI) and polyethylene naphthalate (PEN).

The voltage supplying section 19 supplies a drive voltage Vd to the actuator device 13, and thereby drives (deforms) the actuator device 13. The foregoing voltage supplying section 19 may include, for example, an electric circuit that uses a component such as a semiconductor device. It is to be noted that description will be given later of the detailed operation of the voltage supplying section 19 driving the actuator device 13 (polymer actuator device) (FIG. 4).

### [Detailed Configuration of Actuator Device 13]

Next, description will be given of a detailed configuration of the actuator device 13 configured of the polymer actuator device with reference to FIG. 3. FIG. 3 illustrates a cross-sectional configuration (Z-X cross-section configuration) of the actuator device 13.

The actuator device 13 has a cross-sectional structure in which a pair of electrode films 52A and 52B are formed on both faces of an ion conductive polymer compound film 51 (hereinafter, simply referred to as “polymer compound film 51”). In other words, the actuator device 13 includes the pair of electrode films 52A and 52B and the polymer compound film 51 inserted between the electrode films 52A and 52B. It is to be noted that circumference of the actuator device 13 and of the electrode films 52A and 52B may be covered with an insulating protection film formed of a material with high elasticity (such as polyurethane).

The polymer compound film 51 curves in response to generation of a predetermined potential difference between the electrode films 52A and 52B. The polymer compound film 51 is impregnated with an ionic substance. “Ionic substance” herein refers to general ions that are movable inside the polymer compound film 51. Specifically, “ionic substance” herein refers to substances including a polar solvent and, for example, a hydrogen ion, a simple substance of a metal ion, or a cation and/or an anion thereof, and refers to substances including a cation and/or an anion being liquid itself such as imidazolium salt. Examples of the former include substances in which a polar solvent is solvated in a cation and/or an anion. Examples of the latter include ionic liquid.

Examples of a material configuring the polymer compound film 51 includes an ion-exchange resin that includes, for example, a fluorine resin or a hydrocarbon system as a skeleton thereof. As the ion-exchange resin, a cation-exchange resin is preferable when the polymer compound film 51 is impregnated with a cationic substance, and an anion-exchange resin is preferable when the polymer compound film 51 is impregnated with an anionic substance.

Examples of the anion-exchange resin include a resin to which an acid group such as a sulfonic acid group and a carboxyl group is introduced, in particular, polyethylene including an acid group, polystyrene including an acid group, and a fluorine resin including an acid group. In particular, a fluorine resin that includes a sulfonic acid group or a carboxyl group is preferable as the cation-exchange resin, for example, Nafion (available from E. I. du Pont de Nemours and Company).

The cationic substance that impregnates the polymer compound film 51 may be any kind, for example, may be organic or inorganic. Various materials may be used, for example, a simple substance of a metal ion, a substance including a metal ion and water, a substance including an organic cation and water, ionic liquid, etc. Examples of the metal ion include light-metal ions such as a sodium ion (Na⁺), a potassium ion (K⁺), a lithium ion (Li⁺), and a magnesium ion (Mg²⁺). Moreover, examples of the organic cation include an alkyl ammonium ion. The foregoing cations exist as hydrates in the polymer compound film 51. Therefore, it is preferable that the cationic substance be sealed as a whole so as to suppress volatilization of water in the actuator device 13 when the polymer compound film 51 is impregnated with a cationic substance including a cation and water.

The ion liquid may be a so-called ambient-temperature molten salt and includes a cation and an anion that have low burnability and low volatility. Examples of the ionic liquid include imidazolium-ring-based compounds, pirydinium-ring-based compounds, and aliphatic compounds.

In particular, the cationic substance preferably is ionic liquid since ionic liquid has low volatility, and therefore, the actuator device 13 operates favorably even under high temperature atmosphere or in a vacuum.

The electrode films 52A and 52B that face each other with the polymer compound film 51 in between each include one or more conductive materials. The electrode films 52A and 52B are each preferably formed of conductive material powders bound together by an ion conductive polymer since this increases flexibility of the electrode films 52A and 52B. The conductive material powders are preferably carbon powders. One reason for this is that a larger amount of deformation is obtainable since carbon powders have high conductivity and large specific surface area. Ketjen black is preferable as the carbon powders. Materials similar to those configuring the polymer compound film 51 described above are preferable as the ion conductive polymer.

The electrode films 52A and 52B may be formed as follows, for example. That is, paint in which the conductive material powders and an ion conductive polymer are dispersed in a dispersion medium is applied to both faces of the polymer compound film 51 and is dried. Also, a film-like component including the conductive material powders and the ion conductive polymer may be crimped onto the both faces of the polymer compound film 51.

The electrode films 52A and 52B each may have a multi-layer structure. In this case, it is preferable that the electrode films 52A and 52B each have a structure in which a layer including the conductive material powders bound by the ion conductive polymer and a metal layer are laminated in order from the polymer compound film 51. This allows a potential to be closer to a uniform value in an in-plane direction of the electrode films 52A and 52B, and thereby, further superior deformation performance is obtained. Examples of a material configuring the metal layer include noble metal such as gold and platinum. The metal layer may have any thickness. However, the metal film is preferably a continuous film so that a potential is uniform in the electrode films 52A and 52B. Examples of a method of forming the metal film include plating, deposition, and sputtering.

Dimensions (width and length) of the polymer compound film 51 may be appropriately set depending on factors such as the dimensions and weight of the driving target 9 and displacement amount (deformation amount) necessary in the polymer compound film 51. The displacement amount of the polymer compound film 51 may be set, for example, depending on the necessary displacement amount (moving amount along the Z-axis direction) of the driving target 9.

### [Method of Manufacturing Drive Unit 1]

The drive unit 1 of the present embodiment may be manufactured as follows, for example. That is, first, the actuator device 13 is formed. Specifically, the actuator device 13 configured of the polymer actuator device with the above-described structure is formed in this example.

Next, the reinforcing layer 18 configured of the foregoing material is formed on part or all of the actuator device 13 by attaching the reinforcing layer 18 thereto, for example, with use of an adhesive agent or the like.

Subsequently, the first end portion of the actuator device 13 is fixed by the fixing member 12 that stands on the supporting member 11. Further, a predetermined circuit (such as a semiconductor chip) configuring the voltage supplying section 19 is also attached. Thus, the drive unit 1 shown in FIGS. 1 and 2 is completed.

### [Functions and Effects of Drive Unit 1]

Subsequently, description will be given of functions and effects of the drive unit 1 of the present embodiment.

### [1. Operation of Actuator Device 13]

First, description will be given of operation of the actuator device 13 configured of the polymer actuator device with reference to FIG. 4. FIG. 4 schematically illustrates the operation of the actuator device 13 in a cross-sectional view.

First, a case of using a substance including a cation and a polar solvent as the cationic substance will be described.

In this case, the actuator device 13 without voltage application does not curve and has a planar shape since the cationic substances are dispersed almost uniformly in the polymer compound film 51 (Part (A) of FIG. 4). Here, when the voltage supplying section 19 in Part (B) of FIG. 4 applies a voltage (begins application of a drive voltage Vd), the actuator device 13 behaves as follows. That is, for example, when a predetermined drive voltage Vd is applied between the electrode films 52A and 52B so that the electrode film 52A has a minus potential and the electrode film 52B has a plus potential, the cation moves toward the electrode film 52A with being solvated with the polar solvent. At this time, the anion is hardly movable in the polymer compound film 51. Therefore, the electrode film 52A side of the polymer compound film 51 is swollen and the electrode film 52B side thereof is contracted. Accordingly, the actuator 13 as a whole curves toward the electrode film 52B as shown in Part (B) of FIG. 4. Thereafter, when a potential difference between the electrode films 52A and 52B is eliminated to make a non-voltage application state (stop application of the drive voltage Vd), the cationic substance (the cation and the polar solvent) that has been tilted toward the electrode film 52A in the polymer compound film 51 is diffused and returns to the state shown in Part (A) of FIG. 4. Moreover, when a predetermined drive voltage Vd is applied between the electrode films 52A and 52B in the non-voltage application state shown in Part (A) of FIG. 4 so that the electrode film 52A has a plus potential and the electrode film 52B has a minus potential, the cation moves toward the electrode film 52B with being solvated with the polar solvent. In this case, the electrode film 52A side of the polymer compound film 51 is contracted and the electrode film 52B side thereof is swollen. Therefore, the actuator device 13 as a whole curves toward the electrode film 52A.

Subsequently, a case of using ionic liquid including liquid cation as the cationic substance will be described.

Also in this case, the actuator device 13 without voltage application has the planar shape shown in Part (A) of FIG. 4 since the ionic liquid is dispersed almost uniformly in the polymer compound film 51. Here, when the voltage supplying section 19 applies a voltage (begins application of a drive voltage Vd), the actuator device 13 behaves as follows. That is, for example, when a predetermined drive voltage Vd is applied between the electrode films 52A and 52B so that the electrode film 52A has a minus potential and the electrode film 52B has a plus potential, a cation in the ionic liquid moves toward the electrode film 52A. However, the anion is not movable in the polymer compound film 51 which is a cation-exchange film. Therefore, the electrode film 52A side of the polymer compound film 51 is swollen and the electrode film 52B side thereof is contracted. Accordingly, the actuator 13 as a whole curves toward the electrode film 52B as shown in Part (B) of FIG. 4. Thereafter, when a potential difference between the electrode films 52A and 52B is eliminated to make a non-voltage application state (stop application of the drive voltage Vd), the cation that has been tilted toward the electrode film 52A in the polymer compound film 51 is diffused and returns to the state shown in Part (A) of FIG. 4. Moreover, when a predetermined drive voltage Vd is applied between the electrode films 52A and 52B in the non-voltage application state shown in Part (A) of FIG. 4 so that the electrode film 52A has a plus potential and the electrode film 52B has a minus potential, the cation in the ionic liquid moves toward the electrode film 52B. In this case, the electrode film 52A side of the polymer compound film 51 is contracted and the electrode film 52B side thereof is swollen. Therefore, the actuator device 13 as a whole curves toward the electrode film 52A.

### [2. Operation of Drive Unit 1]

In the drive unit 1, the driving target 9 is driven in accordance with the above-described deformation (curve) of the actuator device 13. Accordingly, the driving target 9 becomes movable (displaceable) along the Z axis as shown by an arrow in Part (A) of FIG. 2.

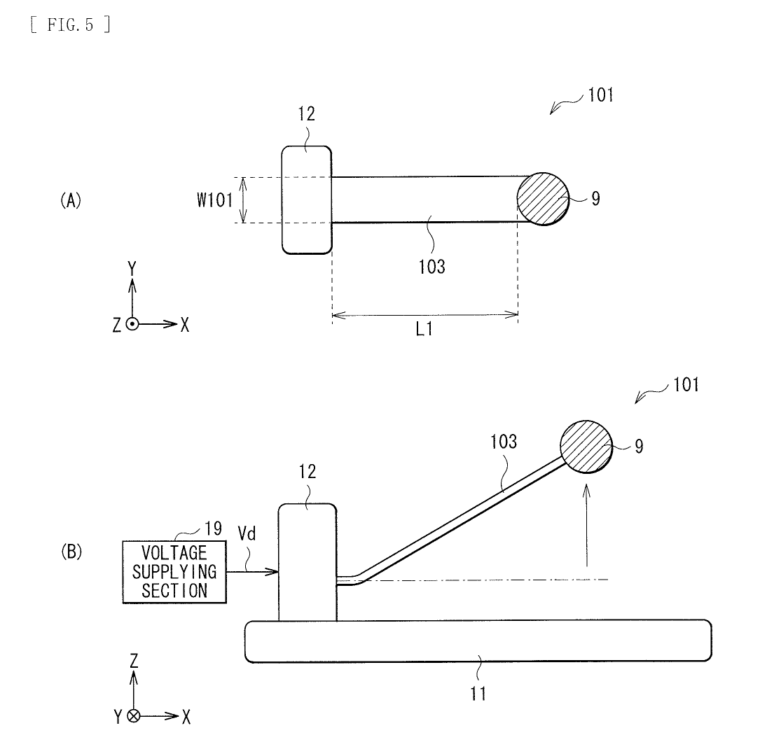

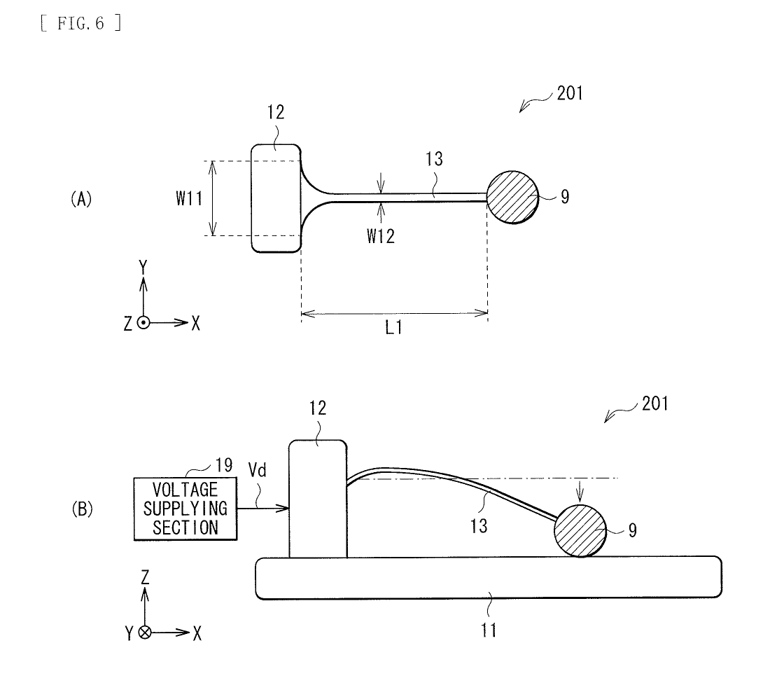

Here, functions and effects of the feature part of the drive unit 1 will be described in detail in comparison with comparative examples. FIG. 5 schematically illustrates an outline configuration and operation of a drive unit (drive unit 101) according to Comparative Example 1. Part (A) shows a planar configuration (X-Y plane configuration, top configuration) thereof and Part (B) shows a side-face configuration (Z-X side-face configuration) thereof. Further, FIG. 6 schematically illustrates an outline configuration and operation of a drive unit (drive unit 201) according to Comparative Example 2. Part (A) shows a planar configuration (X-Y plane configuration, top configuration) thereof and Part (B) shows a side-face configuration (Z-X side-face configuration) thereof.

### Comparative Example 1

First, the drive unit 101 of Comparative Example 1 shown in FIG. 5 does not include the reinforcing layer 18, unlike the drive unit 1 of the present embodiment. Further, in the drive unit 101, an actuator device 103 has a width W101 that is uniform (the same) from a portion closer to the fixing member 12 over a portion closer to the driving target 9. In other words, the width W101 of the actuator device 103 as a whole is larger than the width (in particular, the width W12 of the narrow-width portion) of the actuator device 13 of the present embodiment (W101>W12).

In such a cantilever actuator, it is preferable to allow a width of the cantilever to be as small as possible, for example, in a view of freedom in design (size reduction in structure). However, in the drive unit 101 of Comparative Example 1, it is difficult to reduce the size of the structure (to improve freedom in design) of the drive unit 101 as a whole since the width W101 of the actuator device 103 is large (wide).

### Comparative Example 2

On the other hand, in the drive unit 202 of Comparative Example 2 shown in FIG. 6, the actuator device 13 includes a wide-width portion (with the width W11) closer to the fixing member 12 and includes a narrow-width portion (with the width W12) closer to the driving target 9 as in the drive unit 1 of the present embodiment. Therefore, size reduction in the structure (to improve freedom in design) of the drive unit 201 as a whole is allowed, compared to the above-described drive unit 101 of Comparative Example 1.

However, the drive unit 201 of Comparative Example 2 does not include the reinforcing layer 18, unlike the drive unit 1 of the present embodiment. Therefore, it is difficult to secure strength (mechanical strength) of the actuator device 13 due to the small width (width W12) of the cantilever. Therefore, there may be a case in which the actuator device 13 does not sufficiently drive (displace in a positive direction (upward direction) of the Z axis, in this example) the driving target 9 as shown in Part (B) of FIG. 6, for example. In other words, it is necessary to provide the actuator device 13 with sufficient strength (mechanical strength) to support the driving target 9 by securing a certain width since it is necessary to support the driving target 9 by the cantilever.

As described above, it is difficult to reduce size (improve freedom in design) while maintaining (favorable) drive characteristics in the above-described drive units 101 and 201 of Comparative Examples 1 and 2.

On the other hand, in the drive unit 1 of the present embodiment, the reinforcing layer 18 is provided on part or all of the actuator device 13 as shown in FIGS. 1 and 2. Therefore, mechanical strength of the actuator device 13 is secured even when the width thereof (in particular, the width W12 of the narrow-width portion) is narrowed.

Moreover, it can be said as follows concerning a location to provide the reinforcing layer 18 in the drive unit 1 of the present embodiment. That is, first, in the actuator device 13, the fixed portion (see a region shown by the symbol P11 in Part (A) of FIG. 2) has larger curvature than the movable portion (see a region shown by the symbol P12 in Part (A) of FIG. 2) at the time of deformation. Further, in view of displacement enlarging effect due to the length of the beam, the fixed portion contributes more to displacement at a tip (vicinity of the driving target 9) of the actuator device 13 compared to the movable portion. Therefore, it is the fixed portion that largely contributes to displacement (deformation) of the actuator device 13, and a portion (such as the vicinity of P12) that contributes to the displacement relatively a little has small influence on the displacement amount of the driving target 9 even if the portion is restrained by the reinforcing layer 18. On the other hand, generative force of the actuator device 13 increases in accordance with (substantially in proportion to) increasing width (the width W11 of the wide-width portion in this example) of the fixed portion when rigidity (flexural rigidity) of the cantilever actuator is sufficiently secured. As can be said from the above, it is preferable to provide the reinforcing layer 18, for example, on a middle portion (the vicinity of P12) or on the tip of the cantilever with allowing the width W11 of the fixed portion (wide-width portion) of the actuator device 13 to be sufficiently large. One reason is that this allows setting the width W12 of the portion (narrow-width portion) other than the fixed portion to be dramatically small while sufficiently securing mechanical strength of the actuator device 13.

As described above, the reinforcing layer 18 is provided on part or all of the actuator device 13 in the present embodiment. Therefore, mechanical strength of the actuator device 13 is secured while setting the width (in particular, the width W12 of the narrow-width portion) thereof to be narrow. Therefore, size reduction is achievable while maintaining drive characteristics and freedom in design is improved.

Moreover, the polymer actuator device is used in particular as the actuator device 13. Therefore, the following advantages are obtainable compared to a case of using an actuator device of other scheme (such as a piezoelectric device and a bimetal device described later). That is, the drive voltage Vd is suppressed to be low, and therefore, electric power consumption is reduced. Also, low-cost manufacturing is achieved.

### Modifications

Subsequently, modifications (Modifications 1 to 4) of the above-described embodiment will be described. It is to be noted that components same as those in the embodiment are designated by the same numerals and description thereof will be appropriately omitted.

### Modifications 1 and 2

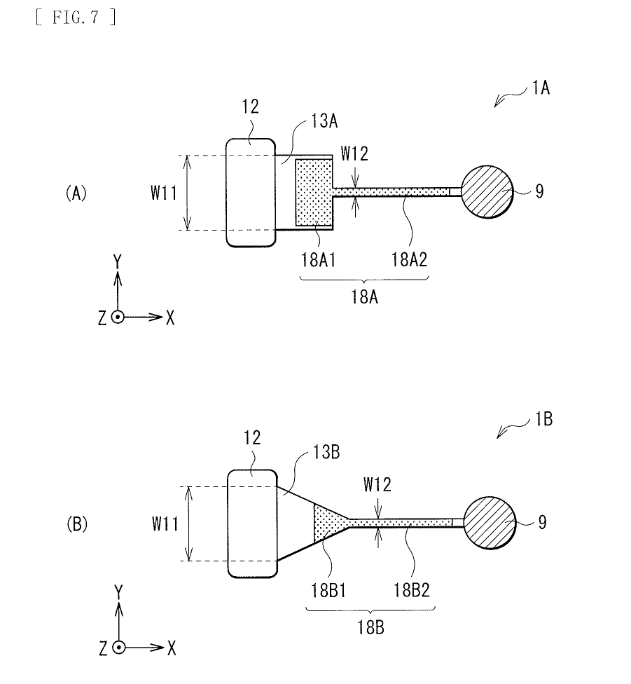

Part (A) of FIG. 7 schematically illustrates an outline configuration of a drive unit (drive unit 1A) according to Modification 1 in a plan view (X-Y plane view, top view). Further, Part (B) of FIG. 7 schematically illustrates an outline configuration of a drive unit (drive unit 1B) according to Modification 2 in a plan view (X-Y plane view, top view).

The drive unit 1A of Modification 1 shown in Part (A) of FIG. 7 includes an actuator device 13A and a reinforcing layer 18A instead of the actuator device 13 and the reinforcing layer 18, respectively, in the drive unit 1 of the above-described embodiment. Other configurations of the drive unit 1A are similar to those of the drive unit 1 of the above-described embodiment.

The actuator device 13A includes a wide-width portion (with the width W11) closer to the fixing member 12 and a narrow-width portion (with the width W12) closer to the driving target 9, as the actuator device 13 of the above-described embodiment. Further, the reinforcing layer 18A has a shape with a width in accordance with the narrow-width portion and the wide-width portion of the actuator device 13A. In other words, the reinforcing layer 18A also has a wide-width portion 18A1 closer to the fixing member 12 and includes a narrow-width portion 18A2 closer to the driving target 9. It is to be noted that the planar shape of the wide-width portion 18A1 is rectangular in this example.

On the other hand, the drive unit 1B of Modification 2 shown in Part (B) of FIG. 7 includes an actuator device 13B and a reinforcing layer 18B instead of the actuator device 13 and the reinforcing layer 18, respectively, in the drive unit 1 of the above-described embodiment. Other configurations of the drive unit 1B are similar to those of the drive unit 1 of the above-described embodiment.

The actuator device 13B includes a wide-width portion (with the width W11) closer to the fixing member 12 and a narrow-width portion (with the width W12) closer to the driving target 9, as the actuator device 13. Further, the reinforcing layer 18B has a shape with a width in accordance with the narrow-width portion and the wide-width portion of the actuator device 13B. In other words, the reinforcing layer 18B also has a wide-width portion 18B1 closer to the fixing member 12 and includes a narrow-width portion 18B2 closer to the driving target 9. It is to be noted that the planar shape of the wide-width portion 18B1 is triangular (a triangular shape with a width gradually narrowed from the portion closer to the fixing member 12 toward the portion closer to the driving target 9) in this example.

As described above, in the Modifications 1 and 2, the reinforcing layers 18A and 18B each have a shape with a width in accordance with the narrow-width portion and the wide-width portion thereof in the actuator devices 13A and 13B. Therefore, mechanical strength of the actuator devices 13A and 13B are more easily secured even when the driving target 9 is especially heavy.

### Modification 3

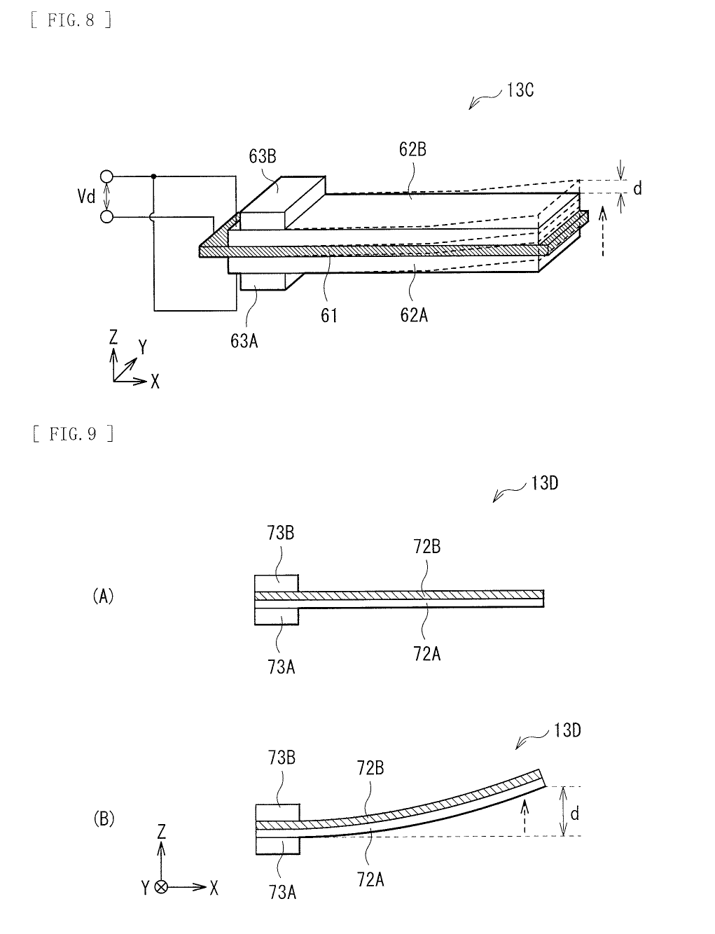

FIG. 8 schematically illustrates, in a perspective view, an outline configuration and operation of an actuator device (actuator device 13C) applied to a drive unit according to Modification 3. The drive unit of the present modification includes the actuator device 13C configured of a piezoelectric device which will be described below, instead of the actuator device 13 configured of the polymer actuator device described in the above embodiment.

The piezoelectric device includes a conductive plate 61 that extends on the X-Y plane, a pair of piezoelectric bodies 62A and 62B arranged on both faces of the conductive plate 61, and a pair of fixing members 63A and 63B that fix first end portions of the conductive plate 61 and of the piezoelectric bodies 62A and 62B.

The conductive plate 61 may be formed, for example, of a material such as phosphor bronze. The piezoelectric bodies 62A and 62B each may be formed, for example, of a piezoelectric material such as lead zirconate titanate (PZT). It is to be noted that a predetermined polarization process is performed on each of the piezoelectric bodies 62A and 62B along a thickness direction thereof (Z-axis direction) and the piezoelectric bodies 62A and 62B have the polarization directions that are directed at the same direction.

The actuator device 13C configured of the piezoelectric device with the above-described configuration operates as follows when a predetermined drive voltage Vd is applied to each of the piezoelectric bodies 62A and 62B. That is, one of the piezoelectric bodies (the piezoelectric body 62A in this example) extends along the X-axis direction, and on the other hand, the other of the piezoelectric bodies (the piezoelectric body 62B in this example) shrinks along the X-axis direction. As a result, the actuator device 13C as a whole curves (is flexed) along the thickness direction thereof (Z-axis direction) and generates a deformation amount d in the Z-axis direction. It is to be noted that, when the polarity of the drive voltage Vd is inversed, a deformation amount d in an opposite direction is obtained in accordance thereto. Thus, the piezoelectric device functions as the actuator device by supplying the drive voltage Vd.

Therefore, effects similar to those of the above-described embodiment is obtained from functions similar to those of the above-described embodiment also in the drive unit of the present modification that uses the foregoing piezoelectric device as the actuator device 13C.

### Modification 4

FIG. 9 schematically illustrates, in a side-face view (Z-X side-face view), an outline configuration and operation of the actuator device (actuator device 13D) applied to a drive unit according to Modification 4. Part (A) illustrates a state before an operation and Part (B) illustrates a state after the operation. The drive unit of the present modification includes an actuator device 13D configured of a bimetal device described below, instead of the actuator device 13 configured of the polymer actuator device described in the above embodiment.

The bimetal device includes a pair of metal plates (a high-expansion metal plate 72A and a low-expansion metal plate 72B having different thermal expansion rates) that extend on the XY plane and a pair of fixing members 73A and 73B that fix first end portions of the metal plates. The high-expansion metal plate 72A and the low-expansion metal plate 72B are attached to each other to form a laminate structure.

The high-expansion metal plate 72A and the low-expansion metal plate 72B each may be formed, for example, of a material in which metal such as manganese (Mn), chromium (Cr), and copper (Cu) is added to an alloy of iron (Fe) and nickel (Ni). The thermal expansion rates of the high-expansion metal plate 72A and the low-expansion metal plate 72B are differentiated by differentiating the amount of the foregoing metal added to the alloy.

When the actuator device 13D configured of the bimetal device with the above-described configuration is brought into a high temperature state compared to the flat state (before-operation state) shown in Part (A) of FIG. 9, the high-expansion metal plate 72A expands more than the low-expansion metal plate 72B. As a result, the actuator device 13D as a whole curves (is flexed) along a thickness direction thereof (Z-axis direction) and generates a deformation amount d in the Z-axis direction. Therefore, the bimetal device functions as the actuator device by varying temperature of the high-expansion metal plate 72A and the low-expansion metal plate 72B with use of a heating section such as a heater which is not illustrated.

Therefore, effects similar to those of the above-described embodiment is obtained from functions similar to those of the above-described embodiment also in the drive unit of the present modification that uses the foregoing bimetal device as the actuator device 13D.

### APPLICATION EXAMPLES

Subsequently, description will be given of application examples (application examples to a lens module and to an image pickup unit: Application Examples 1 and 2) of the drive units according to the above-described embodiment and Modifications 1 to 4.

### Application Example 1

### [Configuration of Mobile Phone 8]

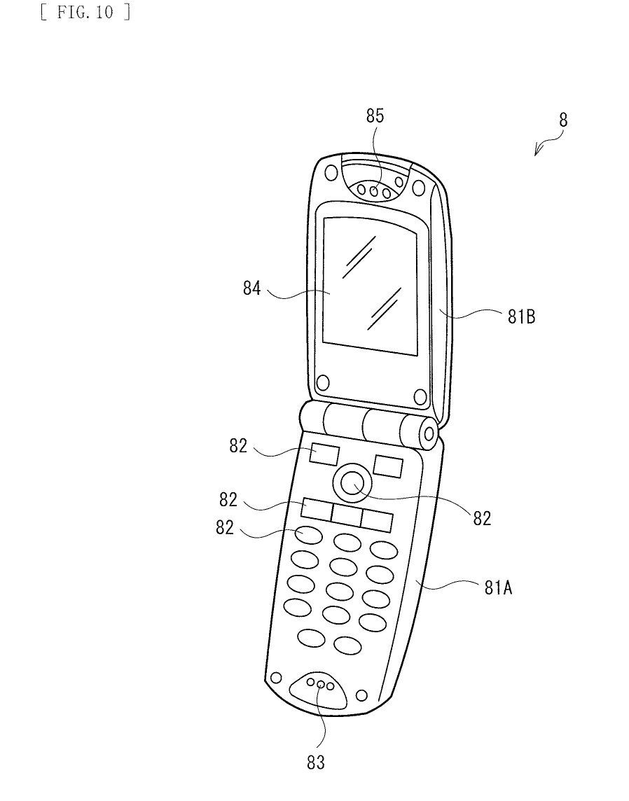

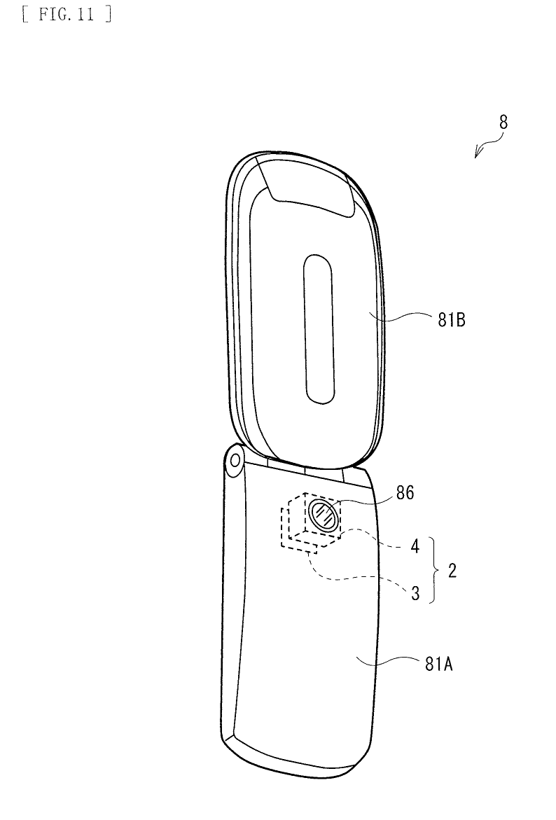

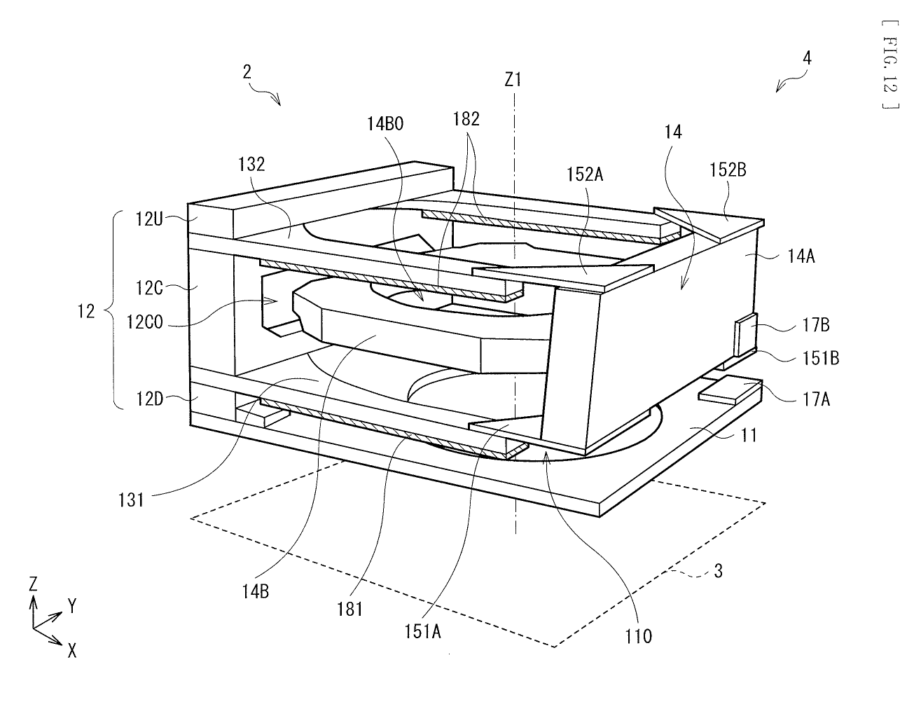

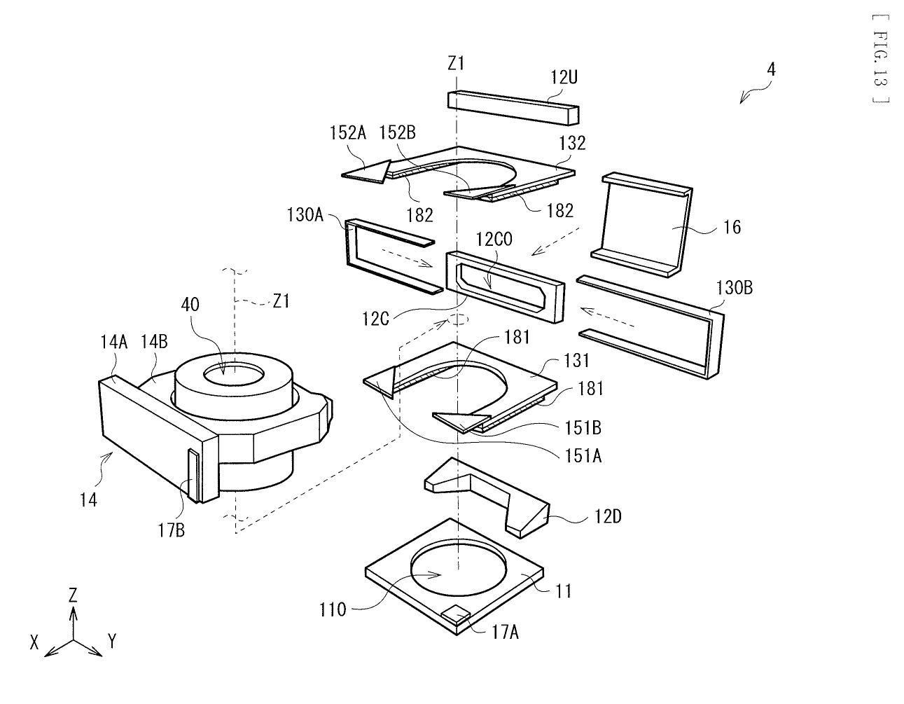

FIGS. 10 and 11 each illustrate, in a perspective view, an outline configuration of a mobile phone (mobile phone 8) with an image pickup function as an example of an electronic apparatus with an image pickup unit according to Application Example 1 of the drive unit of the above-described embodiment and the like. In the mobile phone 8, two housings 81A and 81B are connected to each other through an unillustrated hinge mechanism in a foldable manner.

As shown in FIG. 10, a plurality of various operation keys 82 are provided on a surface on one side of the housing 81A and a microphone 83 is provided on the bottom end of the housing 81A. The operation keys 82 receive predetermined operation by a user and are used to input information. The microphone 83 is used to input voice of the user during phone call etc.

As shown in FIG. 10, a display section 84 using a liquid crystal display panel etc. is provided on a surface on one side of the housing 81B and a speaker 85 is provided on the top end of the housing 81B. The display section 84 may display, for example, various information such as radio wave reception state, remaining amount of battery, a phone number of a person who is on the phone, content stored in a phonebook (phone number, name, etc. of a person), and lists of transmitted call and received call. The speaker 85 outputs voice of the person on the phone etc. during the phone call etc.

As shown in FIG. 11, a cover glass 86 is provided on a surface on the other side of the housing 81A and an image pickup unit 2 is provided in the housing 81A at a position corresponding to that of the cover glass 86. The image pickup unit 2 includes a lens module 4 according to the present application example that is arranged in a region closer to the object (cover glass 86), and includes an image pickup device 3 arranged in a region closer to an image (inside of the housing 81A). The image pickup device 3 is a device that acquires an image pickup signal resulting from imaging by a lens (later-described lens 40) in the lens module 4. The image pickup device 3 is configured of an image sensor that is provided with, for example, a charge coupled device (CCD), a complementary metal oxide semiconductor (CMOS), or the like.

### [Configuration of Image Pickup Unit 2]

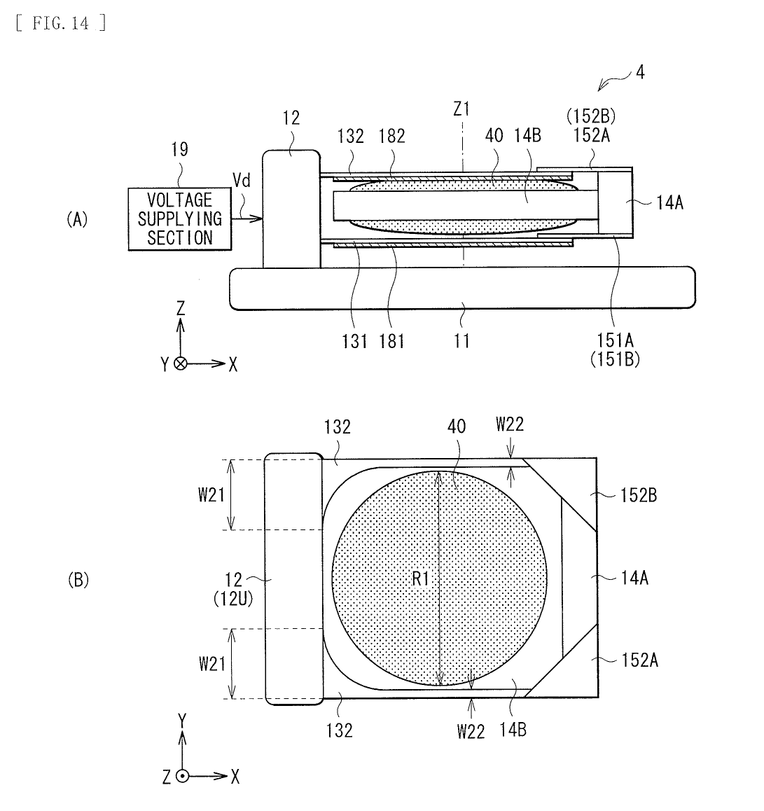

FIG. 12 illustrates, in a perspective view, a main part configuration of the image pickup unit 2. FIG. 13 illustrates, in an exploded perspective view, a configuration of the lens module 4 in the image pickup unit 2. Moreover, FIG. 14 schematically illustrates an outline configuration of the lens module 4 with a side-face view (Z-X side-face view) in Part (A) and a plan view (X-Y plane view) in Part (B).

The lens module 4 includes the supporting member 11, a reinforcing layer 181, an actuator device 131, a lens holding member 14 and a lens 40, reinforcing layer 182, and an actuator device 132 along an optical axis Z1 in order from the image (image pickup device 3) toward the object (along the positive direction of the Z axis). It is to be noted that illustration of the lens 40 is omitted in FIG. 12. The lens module 4 also includes the fixing member 12, coupling members 151A, 151B, 152A, and 152B, fixed electrodes 130A and 130B, a steadying member 16, and hole devices 17A and 17B. It is to be noted that the foregoing members of the lens module 4 except for the lens 40 correspond to specific example of “lens drive unit” of the present invention.

The supporting member 11 is a base material (base) that supports the lens module 4 as a whole.

The fixing member 12 is a member that fixes a first end of each of the actuator devices 131 and 132 in this example. The fixing member 12 includes three members, i.e., a lower fixing member 12D, a central (middle) fixing member 12C, and an upper fixing member 12U that are arranged from the image (bottom parts in FIGS. 12 and 13) toward the object (upper parts in FIGS. 12 and 13). The first end of the actuator device 131 and first ends of the fixed electrodes 130A and 130B are interposed between the lower fixing member 12D and the central fixing member 12C. On the other hand, the first end of the actuator device 132 and second ends of the fixed electrodes 130A and 130B are interposed between the central fixing member 12C and the upper fixing electrode 12U. Further, an opening 12C0 that allows a part of the lens holding member 14 (a part of a holding portion 14B described later) to be partially inserted therethrough is formed in the central fixing member 12C of the foregoing. This allows part of the lens holding member 14 to move inside the opening 12C0. Therefore, space is effectively utilized and the size of the lens module 4 is reduced.

The fixed electrodes 130A and 130B are electrodes that supply the drive voltage Vd received from the foregoing voltage supplying section 19 to the electrode films (the foregoing electrode films 52A and 52B) in the actuator devices 131 and 132. The fixed electrodes 130A and 130B may be formed, for example, of gold (Au), metal plated with gold, etc. and has a U-like shape. Therefore, the fixed electrodes 130A and 130B each sandwich top and bottom of the central fixing member 12C (both side faces along the Z axis) and is allowed to apply the same voltage in parallel to the pair of actuator devices 131 and 132 with small number of wirings. Further, degradation in contact resistance due to a factor such as surface oxidation is prevented when the fixed electrodes 130A and 130B are configured of a metal material plated with gold.

The lens holding member 14 is a member that holds the lens 40. The lens holding member 14 may be formed, for example, of a hard resin material such as liquid crystal polymer. The lens holding member 14 is so arranged that the center thereof is on the optical axis Z1. The lens holding member 14 includes the circular holding portion 14B that holds the lens 40, and includes a connection portion 14A that supports the holding portion 14B and connects the holding portion 14B to the later-described coupling members 151A, 151B, 152A, and 152B. Moreover, the holding portion 14B is arranged between later-described driving faces of the pair of actuator devices 131 and 132.

The actuator devices 131 and 132 each have a driving face (a driving face on the X-Y plane) that is perpendicular to the optical axis Z1 of the lens 40. The actuator devices 131 and 132 are so arranged that the driving faces face each other along the optical axis Z1. The actuator devices 131 and 132 each drive the lens holding member 14 (and the lens 40) along the optical axis Z1 through the later-described coupling members 151A, 151B, 152A, and 152B. Further, the actuator devices 131 and 132 are each configured of the foregoing polymer actuator device in this example. The actuator devices 131 and 132 includes a wide-width portion (with a width W21) closer to the fixing member 12 and a narrow-width portion (with a width W22) in a movable portion (closer to the coupling members 151A, 151B, 152A, and 152B) in this example as shown in Part (B) of FIG. 14.

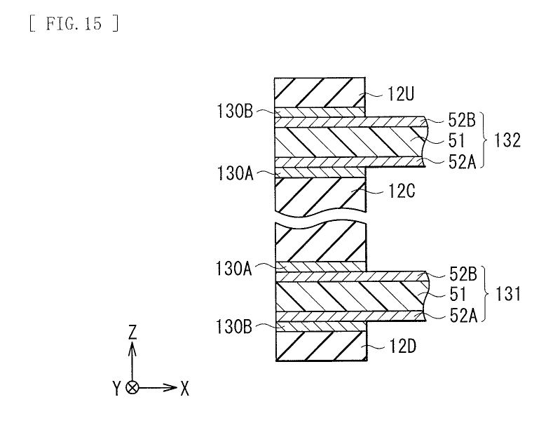

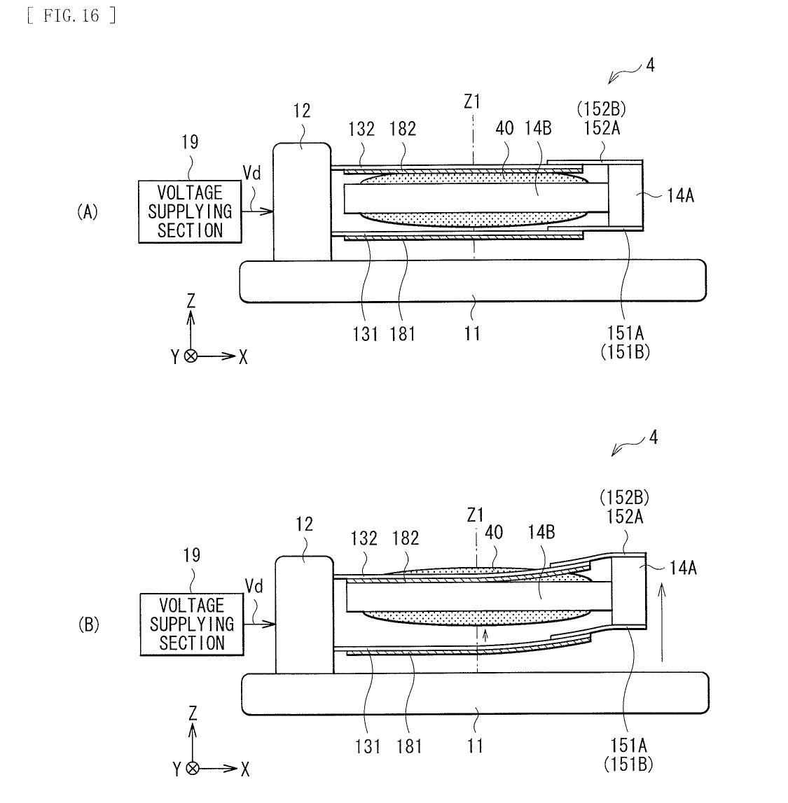

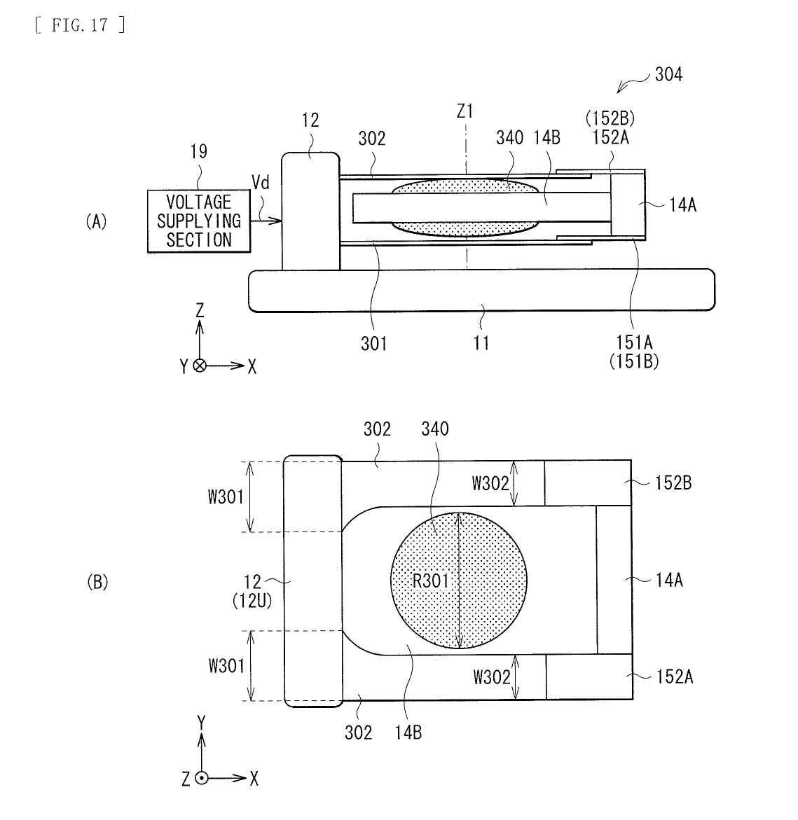

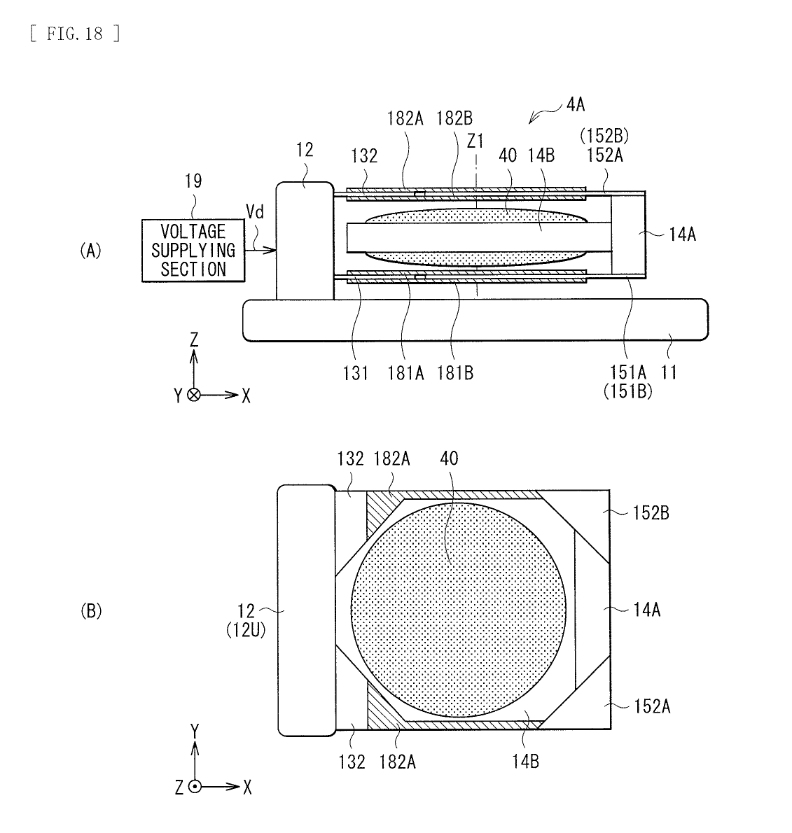

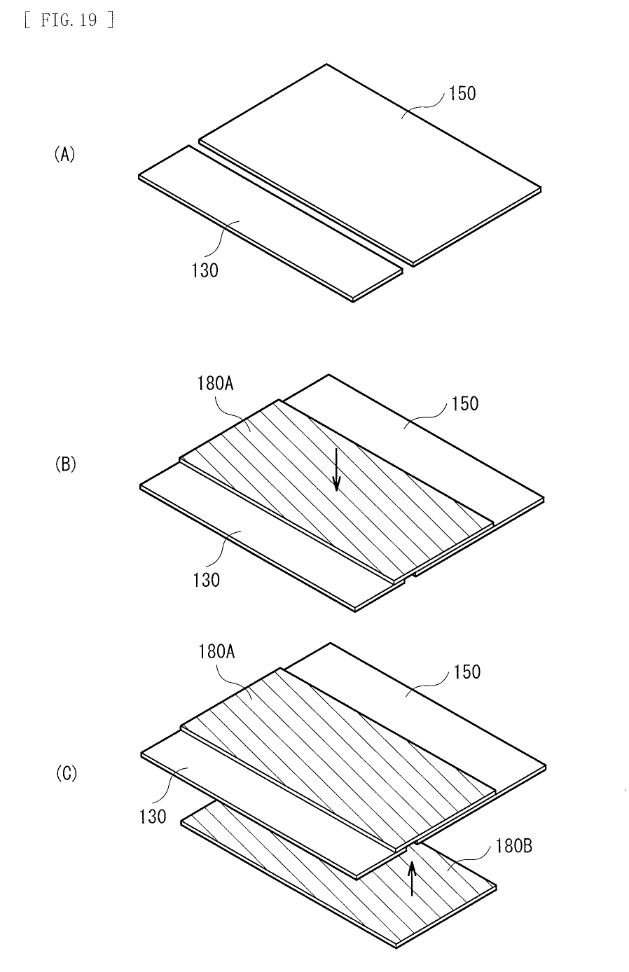

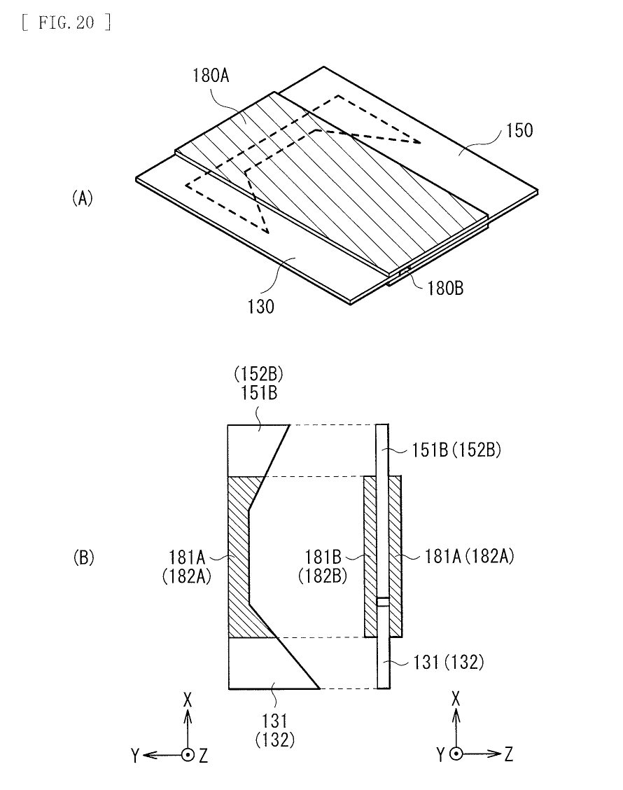

Here, as shown in a cross-sectional view (Z-X cross-section view) in FIG. 15, in the actuator device 131, the electrode film 52A is electrically connected to the fixed electrode 130B on the lower fixing member 12D side thereof and the electrode film 52B is electrically connected to the fixed electrode 130A on the central fixing member 12C side thereof. On the other hand, in the actuator device 132, the electrode film 52A is electrically connected to the fixed electrode 130A on the central fixing member 12C side thereof, and the electrode film 52B is electrically connected to the fixed electrode 130B on the upper fixing member 12U side thereof. It is to be noted that, although not illustrated in FIG. 15, each of the members and the electrodes from the fixed electrode 130B closer to the lower fixing member 12D to the fixed electrode 130B closer to the upper fixing member 12U is sandwiched and fixed by the steadying member 16 (plate spring) shown in FIG. 13 with a certain pressure. Accordingly, the actuator devices 131 and 132 are not destroyed even when a large force is applied thereto and stable electric connection is allowed even when the actuator devices 131 and 132 are deformed.

The reinforcing layers 181 and 182 each correspond to the reinforcing layer 18 described in the above embodiment and are selectively provided on one face (back face) of the flat-plate-like actuator devices 131 and 132 in this example. However, the above-described reinforcing layers 181 and 182 may be provided on both faces (front face and back face) of the actuator devices 131 and 132.

The coupling members 151A, 151B, 152A, and 152B are each a member that couples (connects) an end of the connection portion 14A and second ends of the respective actuator devices 131 and 132. Specifically, the coupling members 151A and 151B each couple a lower end of the connection portion 14A and the second end of the actuator device 131. The coupling members 152A and 152B each couple an upper end of the connection portion 14A and the second end of the actuator device 132. The coupling members 151A, 151B, 152A, and 152B each may be formed, for example, of a flexible film such as a polyimide film and is preferably formed of a flexible material that has rigidity (flexural rigidity) almost equal to or less than (preferably, equal to or less than) that of the respective actuator device 131 and 132. Accordingly, freedom of the coupling members 151A, 151B, 152A, and 152B of curving in a direction opposite to a curving direction of the actuator devices 131 and 132 is provided. Therefore, a cross-sectional shape of the cantilever configured of the actuator devices 131 and 132 and the coupling members 151A, 151B, 152A, and 152B has an S-like curved line. As a result, the connection portion 14A is allowed to travel in parallel along the Z-axis direction and the holding portion 14B (and the lens 40) is driven in the Z-axis direction with maintaining a parallel state with respect to the supporting member 11. It is to be noted that, for example, a spring constant may be used as the above-described rigidity (flexural rigidity).

Here, it is preferable that the following expression (1) is satisfied where S1 is rigidity (flexural rigidity) of the actuator devices 131 and 132, and S2 is rigidity (flexural rigidity) of the reinforcing layers 181 and 182. This allows the widths of the actuator devices 131 and 132 to be set smaller and the size of the lens module 4 to be smaller. Further, it is more preferable that the following expressions (2) and (3) are both satisfied in addition to the expression (1) where S3 is rigidity (flexural rigidity) of the coupling members 151A, 151B, 152A, and 152B. This allows the widths of the actuator devices 131 and 132 to be set further smaller and the size of the lens module 4 to be further smaller.

S2>S1 (1)

S2>S3 (2)

S1>S3 (3)

### [Functions and Effects of Lens Module 4]

FIG. 16 illustrates, in a perspective view, operation of the lens module 4. Part (A) illustrates a state before an operation and Part (B) illustrates a state after the operation.

In the lens module 4, as shown in Parts (A) and (B) of FIG. 16 (an arrow in the drawing), the pair of actuator devices 131 and 132 drive the lens holding member 14, and thereby, the lens 40 is allowed to travel along the optical axis Z1 thereof. Thus, the lens 40 is driven along the optical axis Z1 thereof by the drive unit (lens drive unit) that uses the actuator devices 131 and 132, in the lens module 4.

Here, the reinforcing layers 181 and 182 are provided on part or all of the actuator devices 131 and 132 also in the present application example in a manner similar to that of the above-described embodiment. Therefore, mechanical strength of the actuator devices 131 and 132 is secured even when the widths (in particular, the width W22 of the narrow-width portion) of the actuator devices 131 and 132 are narrowed as shown in Part (B) of FIG. 14. Accordingly, the area of the actuator devices 131 and 132 is reduced, and therefore, an optical device with larger diameter (the lens 40 with a large diameter R1 in this example) is allowed to be provided in the lens module 4.

On the other hand, in a lens module (lens module 304) according to Comparative Example 3 shown in Parts (A) and (B) of FIG. 17, the reinforcing layer as in the present application example is not provided. Therefore, an area of an actuator device 302 is large. Specifically, the wide-width portion (with a width W301) closer to the fixing member 12 and the narrow-width portion (with a width W302) in a movable portion (closer to the coupling members 151A, 151B, 152A, and 152B) are larger than the widths W21 and W22 of the actuator devices 131 and 132. Therefore, a diameter of the optical device (a diameter R301 of a lens 340 in this example) is smaller in the lens module 304 according to Comparative Example 3 compared to in the lens module 4 of the present application example (R1>R301). In other words, it is difficult to provide an optical device with a large diameter in the lens module 304 in Comparative Example 3.

### Application Example 2

### [Configuration of Lens Module 4A]

FIG. 18 schematically illustrates an outline configuration of a lens module 4A according to Application Example 2 in a side-face view (Z-X side-face view) in Part (A) and in a plan view (X-Y plane view) in Part (B). The lens module 4A of the present application example includes reinforcing layers 181A, 181B, 182A, and 182B instead of the reinforcing layers 181 and 182 in the lens module 4 of the above-described Application Example 1. Moreover, in the lens module 4A, a length of the coupling members 151A, 151B, 152A, and 152B in the X-axis direction is set to be longer than the length (length in the X-axis direction) of the beam of the actuator devices 131 and 132, unlike in the above-described Application Example 1.

The reinforcing layers 181A, 181B, 182A, and 182B correspond to the reinforcing layer 18 described in the above embodiment and are provided on both surfaces (front and back faces) of the flat-plate-like actuator devices 131 and 132 in this example.

### [Method of Manufacturing Lens Drive Unit in Lens Module 4A]

Lens drive unit part (the actuator devices 131 and 132, the coupling members 151A, 151B, 152A, and 152B, and the reinforcing layers 181A, 181B, 182A, and 182B) out of those in the lens module 4A of the present application example, in particular, may be manufactured as follows. FIGS. 19 and 20 illustrate an example of processes of manufacturing the lens drive unit part in perspective views, a plan view (X-Y plane view), and a side-face view (Z-X side-face view).

First, as shown in Part (A) of FIG. 19, an actuator device 130 configuring the actuator devices 131 and 132 and a low-rigidity layer 150 (for example, a layer formed of the foregoing materials exhibiting rigidity S3) configuring the coupling members 151A, 151B, 152A, and 152B are arranged with a predetermined space.

Subsequently, as shown in Part (B) of FIG. 19, a high-rigidity layer 180A (for example, a layer formed of the foregoing materials exhibiting rigidity S2) configuring the reinforcing layers 181A and 182A is attached on one surface (front face) of the actuator device 130 and the low-rigidity layer 150 with use of, for example, an adhesive agent or the like. Subsequently, as shown in Part (C) of FIG. 19, a high-rigidity layer 180B (for example, a layer made of the foregoing materials exhibiting rigidity S2) configuring the reinforcing layers 181B and 182B is attached on the other surface (back face) of the actuator device 130 and the low-rigidity layer 150 with use of, for example, an adhesive agent or the like in a similar manner. Thus, the high-rigidity layers 180A and 180B configuring the reinforcing layer are formed on the actuator device 130.

Thereafter, a region shown by a dashed line in Part (A) of FIG. 20 is mechanically cut out, for example, by a process using, for example, a punch, a laser beam, or the like. In other words, the actuator device 130, the low-rigidity layer 150, and the high-rigidity layers 180A and 180B are cut out in a predetermined shape. Accordingly, the lens drive unit in the lens module 4A shown in FIG. 18 is completed as shown in Part (B) of FIG. 20.

Effects similar to those of the above-described Application Example 1 is obtained from functions similar to those of the above-described Application Example 1 also in the lens module 4A of the present application example with the above-described configuration. In other words, the area of the actuator devices 131 and 132 is reduced, and therefore, an optical device with a larger diameter (the lens 40 with a large diameter R1) is allowed to be provided in the lens module 4A.

### Other Modifications

The present invention has been described hereinabove with referring to the embodiment, the modifications, and the application examples as examples. However, the present invention is not limited to the above-described embodiments and the like and may be variously modified.

For example, the connection portion 14A and the coupling members 151A, 151B, 152A, and 152B that are described in the above embodiment and the like may not be provided in some cases. Moreover, description has been given in the above embodiment and the like of a case in which the first end portion of the actuator device is directly fixed by the fixing member; however, this is not limitative. In other words, the first end portion of the actuator device may be indirectly (through a component such as a fixed electrode) fixed by the fixing member.

Moreover, description has been mainly given in the above embodiment and the like of a case in which a pair of actuator devices are provided. However, the actuator devices are not necessarily one pair, and one, or three or more actuator devices may be provided.

Moreover, the shape of each actuator device is not limited to those described in the above embodiment and the like. The laminate configuration of each actuator device is also not limited to those described in the above embodiment and the like and may be appropriately changed. Moreover, for example, a shape, a material, etc. of each member in the lens module (drive unit) are not limited to those described in the above embodiment and the like. For example, the shape of the reinforcing member is not limited to the shapes (such as a layered structure (reinforcing layer)) described in the above embodiment and the like, and may be other shapes.

In addition, the lens drive unit that drives the lens along the optical axis thereof has been described as an example of the drive unit of the present invention in the above embodiment and the like. However, it is not limited to the case, and the lens drive unit may drive the lens along a direction perpendicular to the optical axis thereof, for example. Moreover, the drive unit of the present invention is applicable to those other than the above-described lens drive unit, such as a drive unit that drives an aperture etc. (see Japanese Unexamined Patent Application Publication No. 2008-259381 etc.). Moreover, the drive unit, the lens module, and the image pickup unit of the present invention are applicable to various electronic apparatuses other than the mobile phone described in the above embodiment and the like.

1-20. (canceled)

21. A drive unit comprising:
a fixing member;
an actuator device having a first end portion directly or indirectly fixed by the fixing member; and
a reinforcing member provided on part or all of the actuator device.

22. The drive unit according to claim 21, wherein
the actuator device includes a wide-width portion in the first end portion and includes a narrow-width portion in a second end portion; and
the reinforcing member is provided on part or all of the narrow-width portion.

23. The drive unit according to claim 22, wherein the reinforcing member is provided also on part or all of the wide-width portion.

24. The drive unit according to claim 23, wherein the reinforcing member is provided continuously from the narrow-width portion over the wide-width portion.

25. The drive unit according to claim 24, wherein the reinforcing member has a shape with a width in accordance with the narrow-width portion and the wide-width portion of the actuator device.

26. The drive unit according to claim 21, wherein the drive unit is a lens drive unit driving a lens.

27. The drive unit according to claim 26, further comprising:
a lens holding member holding the lens; and
a coupling member coupling the second end portion of each of a plurality of the actuator devices and an end of the lens holding member, wherein
the plurality of the actuator devices each having a driving face perpendicular to an optical axis of the lens are arranged to allow the driving faces to face each other along the optical axis of the lens, and
the first end portion of each of the plurality of the actuator devices is fixed by the fixing member.

28. The drive unit according to claim 27, wherein S2>S1 is satisfied where S1 is rigidity of the actuator devices and S2 is rigidity of the reinforcing member.

29. The drive unit according to claim 28, wherein S2>S3 and S1≦S3 are further satisfied where S3 is rigidity of the coupling member.

30. The drive unit according to claim 27, wherein
the lens holding member includes
a holding portion holding the lens, and
a connection portion supporting the holding portion and connecting the holding portion to the coupling member, and
the holding portion is arranged between the driving faces of the actuator devices.

31. The drive unit according to claim 30, wherein an opening allowing the holding portion to be partially inserted therethrough is formed in the fixing member.

32. The drive unit according to claim 21, wherein S2>S1 is satisfied where S1 is rigidity of the actuator device and S2 is rigidity of the reinforcing member.

33. The drive unit according to claim 21, wherein
the actuator device has a flat-plate-like shape having a pair of main surfaces that face each other, and
a reinforcing layer is provided as the reinforcing member on one or both of the pair of main surfaces.

34. The drive unit according to claim 21, wherein the actuator device is a polymer actuator device.

35. The drive unit according to claim 34, wherein
the polymer actuator device includes
a pair of electrode films, and
a polymer film inserted between the pair of electrode films.

36. The drive unit according to claim 21, wherein the actuator device is one of a piezoelectric device and a bimetal device.

37. A lens module comprising:
a lens; and
a drive unit driving the lens, wherein
the drive unit includes
a fixing member,
an actuator device having a first end portion directly or indirectly fixed by the fixing member, and
a reinforcing member provided on part or all of the actuator device.

38. An image pickup unit comprising:
a lens;
an image pickup device acquiring an image pickup signal resulting from imaging by the lens; and
a drive unit driving the lens, wherein
the drive unit includes
a fixing member,
an actuator device having a first end portion directly or indirectly fixed by the fixing member, and
a reinforcing member provided on part or all of the actuator device.

39. A method of manufacturing a drive unit, the method comprising:
forming an actuator device;
forming a reinforcing member on part or all of the actuator device; and
directly or indirectly fixing a first end portion of the actuator device by a fixing member.

40. The method according to claim 39, wherein
the forming of the reinforcing member includes
forming a reinforcing layer on the actuator device, and
cutting each of the actuator device and the reinforcing layer into a predetermined shape.
